(19) United States
(12) Patent Application Publication
(10) Pub. No.: US 2004/0148862 A1
(43) Pub. Date: Aug. 5, 2004

(54) WGS reactor incorporated with catalyzed heat exchanger for WGS reactor volume reduction

(76) Inventors: Paul Taichiang Yu, Pittsford, NY (US); Steven D. Burch, Honeoye Falls, NY (US); John C. Fagley, Victor, NY (US); Annette M. Brenner, Honeoye Falls, NY (US); Reena L. Datta, Rochester, NY (US)

Correspondence Address: CARY W. BROOKS, General Motors Corporation, Legal Staff, Mail Code 482-C23-B21, P.O. Box 300, Detroit, MI, 48265-3000, US

(21) Appl. No.: 10/664,503

(22) Filed: Sep. 17, 2003

Related U.S. Application Data
(63) Continuation-in-part of application No. 10/356,681, filed on Jan. 31, 2003.

(51) Int. Cl. C10J 3/20; B01J 8/02

(52) U.S. Cl. 48/214 A; 48/211; 48/212; 48/215; 48/214 R; 48/128; 48/75; 48/102 R; 48/94; 48/95; 422/198; 422/211; 422/189

(57) ABSTRACT

A heat exchanger (60) for a fuel processing system (10) that produces a hydrogen reformate gas. The heat exchanger (60) includes a catalyst for converting carbon monoxide to carbon dioxide. The heat exchanger (60) can be any suitable heat exchanger, such as a tube and fin type heat exchanger, that is able to cool the reformate gas and includes a suitable surface on which the catalyst can be coated. In one embodiment, the heat exchanger (60) is part of a WGS reactor assembly (48). The WGS reactor assembly (48) includes a first stage WGS adiabatic reactor (52) followed by the catalyzed heat exchanger (60) and a second stage WGS adiabatic reactor (68). Also, in one embodiment, both the first stage and the second stage WGS reactors (52, 68) are medium temperature reactors. By catalyzing the heat exchanger (60) in the WGS reactor assembly (48), the assembly (48) can be smaller than what is currently known in the art.

### RELATED APPLICATION

This application is a Continuation-In-Part of U.S. Ser. No. 10/356,681 filed Jan. 31, 2003, in the name of Paul Taichiang Yu, et al. and assigned to the assignee of the present application.

### BACKGROUND OF THE INVENTION

1. Field of the Invention

This invention relates generally to a water-gas shift (WGS) reactor assembly for a fuel processing system that produces hydrogen gas. Particularly, this invention relates to a WGS reactor assembly for a fuel processing system that produces hydrogen gas, where the WGS reactor assembly includes a first stage WGS adiabatic reactor, a catalyzed heat exchanger and a second stage WGS adiabatic reactor.

2. Discussion of the Related Art

Hydrogen is a very attractive source of fuel because it is clean and can be used to efficiently produce electricity in a fuel cell. The automotive industry expends significant resources in the development of hydrogen fuel cells as a source of power for vehicles. Such vehicles would be more efficient and generate fewer emissions than today's vehicles employing internal combustion engines.

A hydrogen fuel cell is an electrochemical device that includes an anode and a cathode with an electrolyte therebetween. The anode receives hydrogen gas and the cathode receives oxygen or air. The hydrogen gas is dissociated in the anode to generate free hydrogen protons and electrons. The hydrogen protons pass through the electrolyte to the cathode. The hydrogen protons react with the oxygen and the electrons in the cathode to generate water. The electrons from the anode cannot pass through the electrolyte, and thus are directed through a load to perform work before being sent to the cathode. The work acts to operate the vehicle. Many fuel cells are combined in a stack to generate the desired power.

Proton exchange membrane (PEM) type fuel cells are a popular fuel cell for vehicles. In a PEM fuel cell, hydrogen (H₂) is the anode reactant, i.e., fuel, and oxygen is the cathode reactant, i.e., oxidant. The cathode reactant can be either pure oxygen or air (a mixture of O₂ and N₂). The PEM fuel cell generally includes a solid polymer electrolyte, such as perflurosulfonic acid. The anode and cathode typically include finely divided catalytic particles, which are often supported on carbon particles and mixed with an isomer. The catalytic particles are typically precious metal particles, and thus are costly. These membrane electrode assemblies (MEA) are relatively expensive to manufacture and require certain conditions for effective operation. These conditions include proper water management and humidification, and control of catalyst poisoning constituents, such as carbon monoxide (CO).

In vehicle fuel cell applications, it is desirable to use a liquid fuel, such as alcohols (methanol or ethanol), hydrocarbons (gasoline), and/or mixtures thereof, such as blends of ethanol/methanol and gasoline, as a source of hydrogen for the fuel cell. Such liquid fuels are easy to store on the vehicle. Further, there is a nationwide infrastructure for supplying liquid fuels. Gaseous hydrocarbons, such as methane, propane, natural gas, LPG, etc., are also suitable fuels for both vehicle and non-vehicle fuel cell applications.

Hydrocarbon-based fuels must be disassociated to release the hydrogen therefrom for fueling the stack. The disassociation reaction is performed within a chemical fuel processor system or reformer. The fuel processor system contains one or more reactors where the fuel reacts with a certain agent to generate a reformate gas comprising primarily hydrogen and carbon dioxide. For example, in a steam methanol reformation process, methanol and water are reacted to generate hydrogen and carbon dioxide. However, carbon monoxide and water are also produced. In a gasoline reformation process, steam, air and gasoline are reacted in an auto-thermal reactor (ATR) or primary reactor that causes two major reactions. One reaction is primarily a partial oxidation reaction (POX) and the other reaction is primarily a steam reforming (SR) reaction.

The known fuel processor systems also typically include downstream reactors, such as water-gas shift (WGS) reactors and preferential oxidation (PROX) reactors. The WGS reactors convert carbon monoxide (CO) to carbon dioxide (CO₂) and shift water to produce as much hydrogen as possible. However, thermodynamically, the WGS reaction cannot completely convert the carbon monoxide, and thus, about 1% of the carbon monoxide exits the WGS reactors. The PROX reactors then remove more of the carbon monoxide from the gas stream by employing catalysts that selectively oxidize carbon monoxide in the hydrogen-rich reformate gas to produce carbon dioxide using oxygen from air as an oxidant. It is desirable that the carbon monoxide in the reformate gas stream be less than 50 ppm to be suitable for fuel cell applications because carbon monoxide contaminates the catalysts in the fuel cell stack.

The gasoline fuel processor technology to date requires large start-up durations, large mass and large volume. The start-up time for a fuel processor system is determined by the time it takes the WGS reactor and the PROX reactor to reduce carbon monoxide in the reformate gas to an acceptable level and supply stack grade hydrogen. Thus, the start-up time is determined by the mass of the WGS and PROX catalysts, and the energy needed to get the catalyst up to temperature.

The reformate gas produced by the ATR or primary reactor is typically in the 700-800° C. temperature range. The most efficient temperature for the exothermic reaction in the WGS reactor to effectively convert the carbon monoxide to carbon dioxide is less than 300° C. However, the temperature that provides the best chemical reaction kinetics within the WGS reactor is greater than 300° C. Therefore, it is known in the art to employ a first stage high temperature WGS reactor (400-500° C.) and a second stage low temperature WGS reactor (200-280° C.) to achieve the desired carbon monoxide to carbon dioxide conversion efficiency within the desired amount of catalyst volume.

A heat exchanger is provided between the primary reactor and the WGS reactor to cool the reformate gas to a temperature suitable for the first stage high temperature WGS reactor. Further, another heat exchanger is provided between the first stage WGS reactor and the second stage low temperature WGS reactor to cool the reformate gas from the first stage WGS reactor to the operating temperature of the low temperature second stage WGS reactor. Also, another heat exchanger is provided between the second stage WGS reactor and the PROX reactor to cool the reformate gas to the operating temperature of the PROX reactor.

It is desirable that the mass and volume of the fuel processing system be minimized, especially if the system is being used directly on the vehicle to satisfy vehicle weight and size requirements. In other words, it is desirable that the fuel processing system has a high power density, which is the ratio of output power to volume of the system. Therefore, it becomes desirable to reduce the size of the various components in the system where appropriate.

### SUMMARY OF THE INVENTION

In accordance with the teachings of the present invention, a heat exchanger for a fuel processing system is disclosed, where the heat exchanger includes a suitable catalyst for converting carbon monoxide to carbon dioxide. The heat exchanger can be any suitable heat exchanger, such as a tube and fin type heat exchanger, that is able to cool a reformate gas propagating therethrough, and includes a suitable surface on which the catalyst can be mounted.

In one embodiment, the heat exchanger is part of a WGS reactor assembly. The WGS reactor assembly includes a first stage WGS adiabatic reactor followed by the catalyzed heat exchanger and a second stage WGS adiabatic reactor. Also, in one embodiment, both the first stage and the second stage WGS reactors are medium temperature reactors. By providing a catalyst within the heat exchanger in the WGS reactor assembly, the assembly can be smaller than what is currently known in the art.

Additional advantages and features of the present invention will become apparent from the following description and appended claims, taken in conjunction with the accompanying drawings.

### BRIEF DESCRIPTION OF THE DRAWINGS

FIG. 1 is a schematic plan view of a fuel processor system, according to an embodiment of the present invention;

FIG. 2 is a schematic plan view of a WGS reactor assembly for the fuel processing system shown in FIG. 1, according to an embodiment of the present invention;

FIG. 3 is a graph with percent CO output concentration on the vertical axis and power level on the horizontal axis showing the CO output of a 12 kWH₂, two stage WGS reactor including a bar and plate heat exchanger coated with a WGS catalyst; and

FIG. 4 is a graph with percent CO output concentration on the vertical axis and power level on the horizontal axis showing the CO output of a 6 kWH₂, two-stage WGS reactor including a tube and shell heat exchanger coated with a WGS catalyst.

### DETAILED DESCRIPTION OF THE INVENTION

The following discussion of the embodiments of the invention directed to a catalyzed heat exchanger for a fuel processing system is merely exemplary in nature, and is in no way intended to limit the invention or its applications or uses. For example, the catalyzed heat exchanger of the invention has particular application for a fuel processing system, but may be used in other systems for reducing carbon monoxide levels or other chemicals.

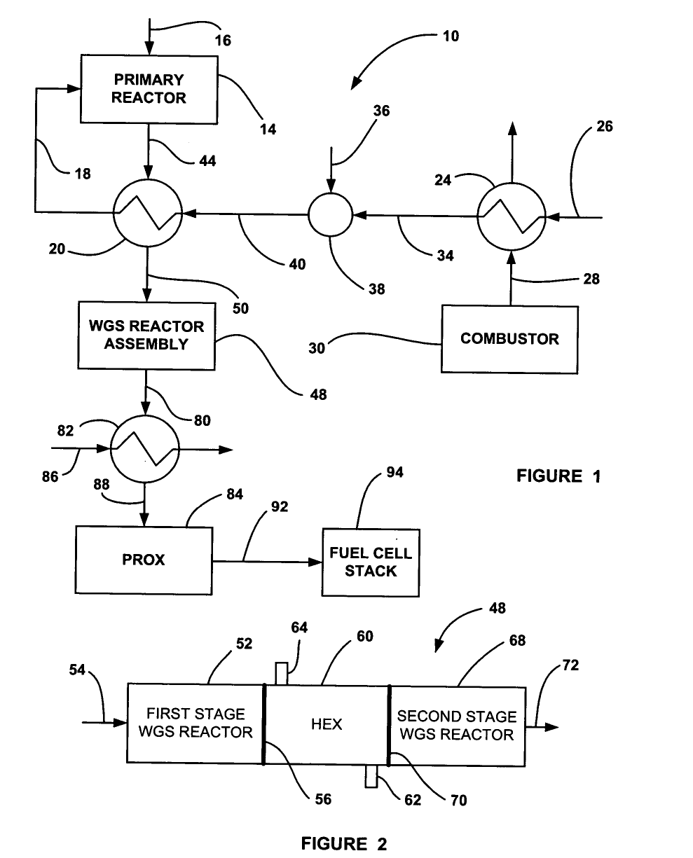

FIG. 1 is a plan view of a fuel processor system 10 for generating a hydrogen rich reformate gas to be used in a fuel cell engine. A hydrocarbon fuel, such as gasoline, natural gas, methane, propane, methanol and/or mixtures thereof, is fed to a primary reactor 14, such as an autothermal reactor, from a suitable source (not shown) on a line 16. The hydrocarbon fuel reacts with a steam/air mixture received on a line 18 from a heat exchanger 20 to dissociate the hydrogen from the fuel and generate a reformate gas including a high concentration of hydrogen. The processing temperature of the reactor 14 depends on the nature of the fuel and the relative compositions of fuel, air and water, and is typically between 300° C. and 800° C. The fuel is converted to hydrogen in the reactor 14 either by partial oxidation, steam reforming or autothermal reforming. The reactor 14 thus includes a steam reforming and/or partial oxidation catalyst suitable for the specific fuel being used. The reformate gas exiting the primary reactor 14 on a line 44 contains primarily hydrogen, nitrogen, carbon monoxide, carbon dioxide, water and possibly methane.

As discussed above, it is necessary to remove most of the carbon monoxide from the reformate gas because carbon monoxide contaminates the catalytic particles used in the fuel cell. The carbon monoxide concentration of the reformate gas on the line 44 is typically between about 5 mole percent and about 20 mole percent. The percent of carbon monoxide needs to be reduced below 50 ppm by volume to be suitable for a fuel cell.

The steam for the steam/air mixture is generated in a heat exchanger 24, where liquid water provided on a line 26 is heated and vaporized in the heat exchanger 24 by a hot exhaust stream on a line 28 from a combustor 30. The steam exits the heat exchanger 24 on a line 34 and is mixed with compressed air provided on a line 36 in a mixing manifold 38. The steam/air mixture exits the manifold 38 on a line 40 to be sent to the heat exchanger 20 to form the hot steam/air mixture on the line 18 sent to the reactor 14. The heat required to raise the temperature of the steam on the line 40 in the heat exchanger 20 is generated by the reformate gas from the reactor 14 on the line 44. Alternately, the air and water can be heated separately and mixed either within or before the primary reactor 14.

The reformate gas on the line 44 is cooled in the heat exchanger 20 to the operational temperature of a WGS reactor assembly 48. The cooled reformate gas is then applied to the WGS reactor assembly 48 on a line 50, where carbon monoxide and water are converted to hydrogen and carbon dioxide by a catalytic exothermic reaction that is well understood in the art. FIG. 2 is a schematic plan view of the WGS reactor assembly 48 separated from the system 10. The WGS reactor assembly 48 includes a first stage WGS adiabatic reactor 52 that receives a reformate gas stream 54 on the line 50. The WGS reactor 52 includes a suitable catalyst that converts carbon monoxide and water to carbon dioxide and hydrogen to reduce the undesirable carbon monoxide and generate more hydrogen in the reformate gas. In one example of a WGS reactor, a honeycomb ceramic monolith is provided within a housing where the catalyst is coated on surfaces of the monolith. The exothermic reaction in the reactor 52 heats the reformate gas.

The reformate gas from the reactor 52 flows through a connector 56 and into a heat exchanger 60 that cools the reformate gas. The heat exchanger 60 receives a coolant, such as air or steam, at an inlet 62 and outputs heated air or steam at an outlet 64. The cooled reformate gas is then applied to a second stage WGS adiabatic reactor 68 through a connector 70 that also includes a suitable catalyst that converts carbon monoxide and water to carbon dioxide and hydrogen to further reduce the carbon monoxide and increase the hydrogen. A reformate gas flow 72 having a low percentage of carbon monoxide exits the reactor 68.

According to the invention, the heat exchanger 60 includes a suitable catalyst that also acts to convert carbon monoxide and water to carbon dioxide and hydrogen. The catalyst can be provided on any appropriate surface within the heat exchanger 60 that comes in contact with the reformate gas flowing therethrough. Metal fins, tubes, plates, housing walls, etc. can all be coated with the catalyst to provide the conversion. Typically, the catalyst will be the same catalyst used in the first and second stage reactors 52 and 68 as those catalysts would be specifically selected for the particular fuel being used and reformate gas temperature. However, the heat exchanger can employ another type of catalyst if appropriate. Because the WGS assembly 48 includes more catalyst for converting carbon monoxide to carbon dioxide than is previously known in the prior art, the first and second stage reactors 52 and 68 can be made smaller because they are required to convert less carbon monoxide. Because the reactors 52 and 68 can be made smaller, the size of the system 10 can be made smaller, which has a direct impact on the vehicle requirements.

The reactors 52 and 68 can be high temperature, medium temperature or low temperature reactors depending on the particular system and fuel being processed. In one embodiment, the first stage reactor 52 and the second stage reactor 68 are medium temperature WGS reactors, i.e., have an operating temperature in the range of 300-400° C. The reformate gas stream 54 enters the reactor 52 at about 300° C. and a speed of 0.881 mole/s (on a 70 kW hydrogen output basis). The air, steam or liquid water at the inlet 62 has a temperature of 27° C. and a speed of 0.28 mole/s and exits the heat exchanger 60 at 360° C. The reformate gas enters the heat exchanger 60 at 370° C. and exits the heat exchanger 60 at about 310° C. The reformate gas then exits the second stage reactor 68 at about 315° C.

The catalyst used in the reactors 52 and 68 and the heat exchanger 60 is typically a suitable precious metal. The catalyst comes as a fine powder that is mixed with a bonding material, such as water, to form a slurry. The honeycomb structure in the reactors 52 and 68 and the structure within the heat exchanger 60 are dipped in the slurry so that it is coated on the appropriate surfaces, where it dries and is calcined. Conventional catalysts, such as Fe₃O₄/Cr₂O₃ for high temperature or CuO/ZnO for low temperature, may be used, as well as any other known WGS catalyst suitable for this application.

The heat exchanger 60 can be any type of heat exchanger suitable for the purposes described herein. In one embodiment, the heat exchanger 60 is a tube and fin heat exchanger, well known to those skilled in the art. The heat exchanger 60 is rearranged by using the tube side as the cooling side and the fin side as the reactant side. Another example of a suitable heat exchanger is a bar and plate type heat exchanger or a tube and shell typ heat exchanger, well known to those skilled in the art.

Table 1 below gives data for a tube and fin type heat exchanger and WGS reactor for both a catalyzed and an uncatalyzed heat exchanger. The left side of Table 1 shows the baseline un-coated heat exchanger data, and the right side of Table 1 shows the improvement in volume, mass and thermal mass assuming a 10% increase of heat exchanger size in order to compensate the loss of heat transfer efficiency due to catalyst coating on the heat exchanger 60. The results show a savings of 17% in volume, 7% mass and 8% thermal mass for a WGS reactor assembly including an inter-stage heat exchanger.

TABLE I

| | Baseline (un-coated) | | | | 10% increase of heat exchanger | | | | |
|---|---|---|---|---|---|---|---|---|---|
| | 1st | | 2nd | | 1st | | 2nd | | |
| | Stage | | Stage | | Stage | | Stage | | |
| | WGS | HEX | WGS | total | WGS | HEX | WGS | total | Δ % |
| Volume | 0.77 | 1.30 | 1.37 | 3.44 | 0.77 | 1.43 | 0.66 | 2.86 | −16.9% |
| (L) | | | | | | | | | |
| Mass | 1.07 | 2.35 | 1.82 | 5.24 | 1.07 | 2.79 | 1.00 | 4.86 | −7.2% |
| (kg) | | | | | | | | | |
| Thermal | 780.82 | 1309. | 1338.6 | 3428.41 | 780.82 | 1632.6 | 726.7 | 3140.16 | −8.4% |
| Mass (J/K) | | | | | | | | | |

The WGS reactor assembly 48 provides the reformate gas flow 72 on a line 80 that is primarily hydrogen, nitrogen, carbon monoxide, carbon dioxide and water. The reformate gas will typically include about 0.3-1 mole percent carbon monoxide depending on the exit temperature of the WGS reactor assembly 48, the space velocity of the reformate gas on the line 80, the steam to carbon ratio and the catalyst used.

The reformate gas on the line 80 is cooled in a heat exchanger 82 to the operating temperature of a PROX 84 (100° C.-200° C.) by a coolant stream on a line 86 applied to the heat exchanger 82. The coolant stream on the line 86 can be air, steam or liquid water that is preheated and subsequently fed into the system 10 on the line 86. The cooled reformate gas leaves the heat exchanger 82 on a line 88 as a wet reformate gas, which includes CO₂, H₂, CO, N₂ and a trace amount of methane.

The reformate gas on the line 88 is sent to the PROX 84. As is known in the art, a PROX also includes a catalyst that further reduces the carbon monoxide level in the reformate gas to less than 50 ppm. The reformate gas with enriched hydrogen and minimal carbon monoxide is output from the PROX on a line 92 and is applied to a fuel cell stack 94. In an alternate embodiment, where the fuel processing system is not provided on the vehicle, the reformate gas on the line 92 can be sent to compressed tanks for storage and later transferred to the vehicle.

As discussed above, the heat exchanger 60 within the WGS reactor assembly 48 includes a catalyst. However, according to the invention, any of the heat exchangers that cool the reformate gas in the processing system 10, or other processing system, can also include a catalyst for converting carbon monoxide to carbon dioxide within the scope of the present invention. Therefore, suitable surfaces within one or both of the heat exchangers 20 and 82 may include such a catalyst, further reducing the size and volume of the system 10.

Advantages of the invention include reduced start-up time because the system 10 reduces the thermal mass of the WGS reactor assembly 48. Also, if hot gas from the combustor 30 can be introduced into the heat exchanger 60 during start-up, this would warm up the WGS reactor assembly 48 and make the fuel processor system 10 start producing hydrogen more quickly. Further, the invention may reduce the amount of catalyst needed because the invention takes advantage of the temperature gradient from the first stage reactor output temperature of 370° C. down to the second stage reactor input temperature of 300-310° C. For this temperature gradient, it would enhance shift reaction kinetics and reduce the use of catalysts.

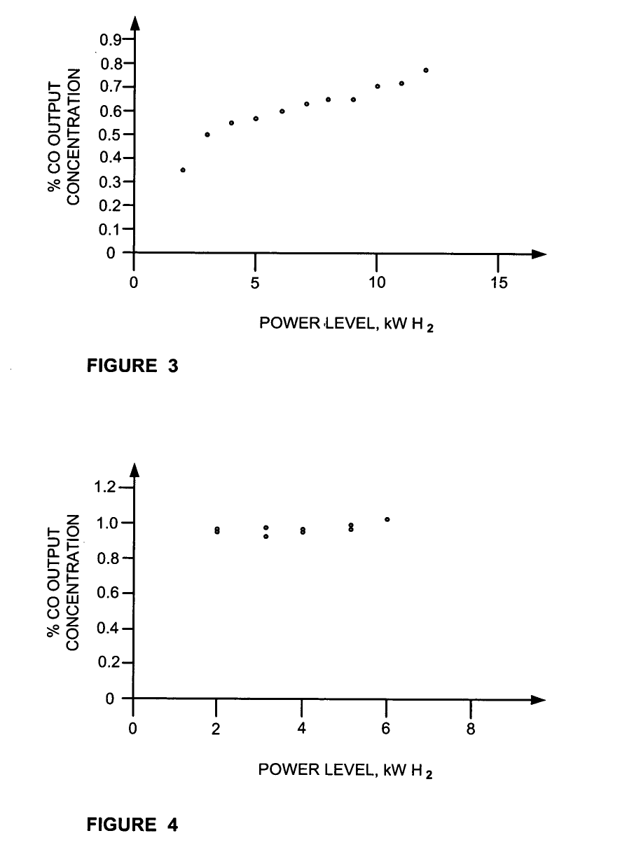

FIG. 3 is a graph with percent CO output concentration on the vertical axis and power level in kW of H₂ on the horizontal axis for a 12 kW H₂, two-stage WGS reactor employing a bar and plate heat exchanger coated with a WGS catalyst. FIG. 4 is the same graph as shown in FIG. 3, but for a 6 kWH₂, two-stage WGS reactor with a tube and shell heat exchanger coated with a WGS catalyst.

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

What is claimed is:

1. A water-gas shift reactor system comprising:
a first stage water-gas shift reactor receiving a reformate gas, said first stage reactor including a catalyst that converts carbon monoxide and water to carbon dioxide and hydrogen;
a heat exchanger receiving the reformate gas from the first stage reactor, said heat exchanger cooling the reformate gas, said heat exchanger including a catalyst that converts carbon monoxide and water to carbon dioxide and hydrogen; and
a second stage water-gas shift reactor receiving the cooled reformate gas from the heat exchanger, said second stage reactor including a catalyst that converts carbon monoxide and water to carbon dioxide and hydrogen.

2. The system according to claim 1 wherein the heat exchanger is selected from the group consisting of a tube and fin heat exchanger, a tube and shell heat exchanger and a bar and plate heat exchanger.

3. The system according to claim 1 wherein the catalyst is selected from the group consisting of precious metals, Fe₃O₄/Cr₂O₃ and CuO/ZnO.

4. The system according to claim 1 wherein the first and second stage reactors are medium temperature water/gas shift reactors that operate in the 300-400° C. range.

5. The system according to claim 1 wherein the first stage reactor is a high temperature reactor operating in the 400-500° C. range and the second stage reactor is a low temperature reactor operating in the 200-280° C. range.

6. The system according to claim 1 wherein the water-gas shift reactor system is part of a fuel processing system for producing hydrogen for a fuel cell.

7. The system according to claim 6 wherein the water-gas shift reactor system is positioned between a primary reactor and a preferential oxidation reactor in the fuel processing system.

8. The system according to claim 1 wherein the reformate gas enters the first stage reactor at a temperature of about 300° C. enters the heat exchanger at a temperature of about 370° C., enters the second stage reactor at a temperature of about 310° C. and exits the second stage reactor at a temperature of about 315° C.

9. The system according to claim 8 wherein the heat exchanger uses air, steam or liquid water to cool the reformate gas.

10. The system according to claim 9 wherein the air enters the heat exchanger at ambient temperature and exits the heat exchanger at about 360° C.

11. A heat exchanger for cooling a main fluid, said heat exchanger comprising:
an inlet for receiving a cooling fluid;
an internal structure through which the cooling fluid and the main fluid propagate, said structure including a catalyst that converts carbon monoxide to carbon dioxide in the main fluid; and
an outlet through which heated cooling fluid exits the heat exchanger.

12. The heat exchanger according to claim 11 wherein the main fluid is a reformate gas flowing in a hydrogen fuel processing system.

13. The heat exchanger according to claim 12 wherein the heat exchanger is positioned between a primary reactor and a water-gas shift reactor in the fuel processing system.

14. The heat exchanger according to claim 12 wherein the heat exchanger is positioned between a water-gas shift reactor and a preferential oxidation reactor in the fuel processing system.

15. The heat exchanger according to claim 12 wherein the heat exchanger is positioned within a water-gas shift reactor assembly in the fuel processing system.

16. The heat exchanger according to claim 15 wherein the heat exchanger is positioned between a first stage reactor and a second stage reactor.

17. The heat exchanger according to claim 16 wherein the first and second stage reactors are medium temperature water-gas shift reactors operating in the 300-400° C. range.

18. The heat exchanger according to claim 11 wherein the catalyst is selected from the group consisting of precious metals, Fe₃O₄/Cr₂O₃ and CuO/ZnO.

19. The heat exchanger according to claim 11 wherein the internal structure is selected from the group consisting of a tube and fin structure, a bar and plate structure and tube and shell heat structure.

20. A fuel processing system for producing a hydrogen reformate gas, said system comprising:
a primary reactor, said primary reactor receiving a liquid hydrocarbon fuel and generating a reformate gas including hydrogen and carbon monoxide;
a first heat exchanger, said first heat exchanger receiving the reformate gas from the primary reactor and cooling the reformate gas;
a water-gas shift reactor assembly including a first stage water-gas shift reactor receiving the cooled reformate gas from the first heat exchanger, a second heat exchanger receiving the reformate gas from the first stage reactor, said second heat exchanger cooling the reformate gas, and a second stage water-gas shift reactor receiving the cooled reformate gas from the second heat exchanger, each of the first stage reactor, second heat exchanger and second stage reactor including a catalyst that converts carbon monoxide and water to carbon dioxide and hydrogen;
a third heat exchanger, said third heat exchanger receiving the reformate gas from the second stage reactor and cooling the reformate gas; and
a preferential oxidation reactor, said preferential oxidation reactor receiving the cooled reformate gas from the third heat exchanger, said preferential oxidation reactor including a catalyst that selectively oxidizes carbon monoxide to carbon dioxide in the reformate gas.

21. The system according to claim 20 wherein one or both of the first and third heat exchangers include a catalyst that converts carbon monoxide and water to carbon dioxide and hydrogen.

22. The system according to claim 20 wherein the first, second and third heat exchangers are selected from the group consisting of tube and fin heat exchangers, bar and plate heat exchangers and tube and shell heat exchangers.

23. The system according to claim 20 wherein the catalyst is selected from the group consisting of precious metals, Fe₃O₄/Cr₂O₃ and CuO/ZnO.

24. A method of cooling a reformate gas in a fuel processing system, comprising:
providing a heat exchanger including a catalyst that converts carbon monoxide and water to carbon dioxide and hydrogen by an exothermic reaction; and
causing the reformate gas to flow through the heat exchanger to be cooled.

25. The method according to claim 24 further comprising positioning the heat exchanger between a first stage water-gas shift reactor and a second stage water/gas shift reactor.

26. The method according to claim 25 wherein the water-gas shift reactors are medium temperature reactors.

27. The method according to claim 24 further comprising positioning the heat exchanger between a primary reactor and a water-gas shift reactor.

28. The method according to claim 24 further comprising positioning the heating exchanger between a water-gas shift reactor and a preferential oxidation reactor.
